(19) United States
(12) Patent Application Publication
(10) Pub. No.: US 2022/0176308 A1
(43) Pub. Date: Jun. 9, 2022

(54) AIR FILTRATION STRUCTURE TO CONTAIN AND SUPPORT ACTIVATED CARBON WITHIN AN AIRSTREAM

(71) Applicant: Columbus Industries, Inc., Ashville, OH (US)

(72) Inventors: Vivekanand Gaur, Dublin, OH (US); Russell L. Baldinger, El Paso, TX (US)

(21) Appl. No.: 17/541,773

(22) Filed: Dec. 3, 2021

Related U.S. Application Data
(60) Provisional application No. 63/121,431, filed on Dec. 4, 2020.

(51) Int. Cl. B01D 53/04; B01D 46/00

(52) U.S. Cl. CPC B01D 53/0407; B01D 46/0036; B01D 2259/4148; B01D 2257/708; B01D 2253/102

(57) ABSTRACT

A filter for removing gaseous components from a gas stream. The filter includes a frame with outer members and support members mounted thereto. The filter includes a prefilter layer disposed upstream in the frame and a reactive layer disposed in the frame downstream from the prefilter layer. The reactive layer includes particulate that removes gaseous components from the gas stream. A containment layer is disposed in the frame downstream from the reactive layer. The frame supports the layers from the airstream flowing through the filter. This configuration reduces the quantity of reactive material required and permits significant variability in the reactive materials used on the reactive layers because the different reactive layers have little to no effect on one another.

### BACKGROUND OF THE INVENTION

The invention relates generally to air purification, and more specifically to structures that remove gaseous chemicals from an air stream.

It is known to use materials to remove unwanted gaseous components from an airstream. Removal typically occurs by placing the materials in contact with the gases so that the materials react with the gases, catalyze a reaction involving the gases or absorb or adsorb the gases. A common material used in such air cleaning systems is carbon particulate, including activated carbon, and the carbon particulate may be in pellet or granular form with the airstream directed to flow over the surface of the carbon particulate.

The conventional configuration for suspending granular or pelletized carbon in an airstream for the purpose of removing volatile organic compounds (VOC) or other undesirable gases from an airstream is a multicellular structure, which is often made of paper or plastic. Multiple, discrete compartments or cells (in one or more of multiple shapes such as a triangle, a diamond, a hexagon, etc.) are linked together to form a porous panel structure that can be filled with activated carbon or other particulate. Each of the cells contains a similar quantity of the particulate, and each of the cells permits air to pass therethrough so the air can make contact with at least some of the carbon in each cell. Containment layers on the upstream and downstream side of the panel retain the carbon in the cells and inhibit loss of the carbon to the airstream. An example of this technology is found in U.S. Pat. No. 10,124,317 to Baldinger.

One problem with the conventional design of the multicellular structure described above is that when the completed filter is placed in a vertical position in the airstream, the carbon particulate physically settles down in each cell due to gravity and vibration. This creates an open gap or void at the top of each cell that allows air to pass through the filter without coming into sufficient contact with the carbon to remove all unwanted gases. As a result, it takes longer to remove contaminants from the air using this configuration. To compensate for this, a common practice is to make deeper carbon beds that use more carbon to clean the air faster. However, this results in greater cost. Another solution is to modify the shape of the passage through the multicellular structure, which is shown in the above-cited patent.

A more recent development in carbon filter construction is a configuration in which carbon particulate is adhered to the surface of a flexible net using a hot melt adhesive. These “netted layers” of carbon permit air to pass through and contact significant surface area of the carbon to the air and its components. The netted layers can be stacked upon each other to provide the mass of carbon needed to remove unwanted odors and/or VOC's from the surrounding air. The netted layer carbon elements are commonly sewn into a pouch made of a fine plastic netting, which does not provide structural support, but which retains some or all of the carbon. Such a pouch system permits the netted layer elements to be maintained in a position that gravity does not favor. However, because the netted layers fold or fall over without outside support, the netted layers must be contained in some fashion when used in a vertical orientation or any other orientation in which gravity does not tend to maintain the shape and orientation of the layers.

Another conventional configuration is a pleated filter containing carbon-impregnated filtration media. In such a configuration, much smaller carbon granules are trapped between two layers of filtration media while adhesive bonds the entire structure together. This configuration produces good results in suspending the carbon in the airstream, but it also has a tendency to capture contaminants that off-gas unwanted odors. This style of filter also typically has a higher resistance to airflow, and therefore requires either a larger filter for a given air-moving device to be able to accommodate or a larger, louder air-moving device to clean the air as efficiently. While this configuration provides a means of evenly distributing carbon in the airstream while providing a means of preventing the individual carbon granules from settling, such filtration medium layers are highly flexible and may not retain their shapes in conventional airstreams. The need exists for filters that have high levels of exposure of gaseous constituents to components of the filter that remove the gaseous constituents.

### SUMMARY OF THE INVENTION

Disclosed herein is a filter with a configuration that causes gaseous component removal with high levels of contact with activated carbon or other particulate. Simultaneously, the filter has a high degree of variability due to the construction, and this variability permits designs that are not possible or cost-effective with conventional configurations.

Disclosed herein is a filter for removing gaseous components from a gas stream. The filter comprises a frame having at least one outer member and at least one support member mounted to the outer member. The filter includes a prefilter layer disposed in the frame and at least one reactive layer disposed in the frame downstream from the prefilter layer. The reactive layer includes particulate that removes at least some of the gaseous components from the gas stream. The filter includes a containment layer disposed in the frame downstream from the reactive layer.

In some embodiments, the particulate in the reactive layer is adhered to a net. In some embodiments, the particulate is activated carbon. In some embodiments, the reactive layer further comprises a first reactive layer with particulate adhered to a net and a second reactive layer with particulate adhered to a net. The first reactive layer differs from the second reactive layer in its removal of gaseous components from the gas stream.

Disclosed herein is a filter for removing gaseous components from a gas stream flowing along a path from upstream to downstream. The filter comprises a rectangular frame defined by four outer members disposed around a frame periphery. The frame includes at least one support member connected at opposite ends to at least two of the four outer members and spanning a gap between at least two of the four outer members. The filter includes a prefilter layer disposed in the frame and at least one reactive layer disposed in the frame downstream from the prefilter layer. The reactive layer may include particulate that removes at least some of the gaseous components from the gas stream. The filter includes a containment layer disposed in the frame downstream from the at least one reactive layer.

In some embodiments the frame has an upstream part with an upstream-facing surface and a downstream part with a downstream-facing surface. The upstream part and the downstream part are separated along a separating plane between the upstream-facing and downstream-facing surfaces, and the separating plane is substantially parallel to the at least one reactive layer. In some embodiments, the prefilter layer is molded into the upstream part and the containment layer is molded into the downstream part. In some embodiments, the particulate in the reactive layer is adhered to a net. In some embodiments the particulate is activated carbon. In some embodiments, the reactive layer further comprises a first reactive layer with particulate adhered to a net and a second reactive layer with particulate adhered to a net. The first reactive layer differs from the second reactive layer in its removal of gaseous components from the gas stream.

### BRIEF DESCRIPTION OF THE DRAWINGS

FIG. 1 is an exploded view in perspective illustrating an embodiment of the present invention.

FIG. 2 is a front view illustrating an embodiment of the present invention.

FIG. 3 is a side view in section of the embodiment of FIG. 2 through the line A-A.

FIG. 4 is a top view illustrating the embodiment of FIG. 2.

FIG. 5 is a magnified view of FIG. 3.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Patent application Ser. No. 63/121,431, which was filed on Dec. 4, 2020 and is the priority application, is incorporated in this application by reference.

A filter according to the invention has several components. As shown in FIGS. 1-5, the filter apparatus 10 includes a frame 1, at least one upstream prefilter layer 2, at least one reactive layer 3 and at least one downstream containment layer 4. Alternative embodiments of the invention may vary in the number of each component, as will be understood by the person of ordinary skill from the description herein. For example, some embodiments may have two reactive layers and two containment layers. In some embodiments, all reactive layers may be the same, and in some embodiments, some components of the reactive layers are the same and some are different.

The frame 1 has outer members 5′ that form a periphery. The outer members 5′ may form a rectangle, a square, a triangle, a hexagon or any other shape. The outer members 5′ are preferably attached to one another at opposite ends and arranged in a planar shape, but in other embodiments may be cylindrical or other shapes. The frame 1 may also have inner supports 5 that are attached at one end to one of the outer members 5′, such as by being integral due to molding the frame's outer members 5′ and inner supports 5 as one piece, and extend to attachment at an opposite end to another outer member 5′. The inner supports 5 may alternatively attach to the outer members 5′ by welding, adhesive or any other fastener. The inner supports 5 support the outer members 5′ against deformation, and provide support to other structures, such as the upstream prefilter layer 2, the reactive layer 3 and the containment layer 4, that may be extended across the span between outer members 5′, against deformation.

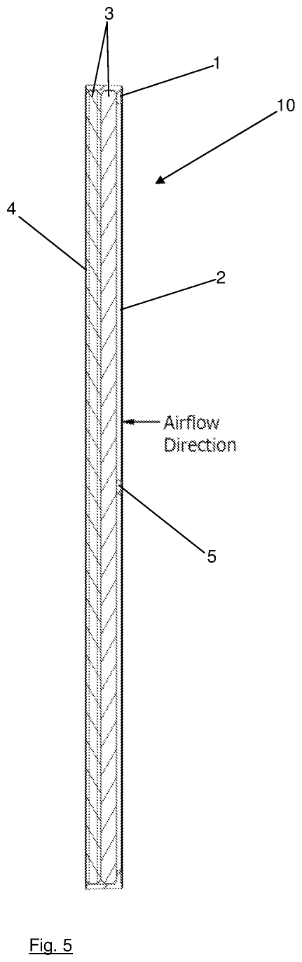

The upstream prefilter layer 2 may be a prefilter material that is adhered, molded into, or otherwise fixed to the upstream-facing side of the frame 1 as shown in the combined apparatus 10 in FIG. 5, which shows the airflow direction. The prefilter layer 2 may be adhered, welded or otherwise fixed to the outer members 5′ and possibly also to the inner supports 5. In FIG. 5, the air strikes the upstream-facing side of the filter apparatus 10 first, and then progresses in a downstream direction through the rest of the apparatus 10. The prefilter 2 may be any material that is a suitable prefilter material, which typically removes at least some particulate or other solids from the airstream, and may not appreciably affect pressure drop across the apparatus 10. The prefilter layer 2 may separate large particles from the air stream before the air reaches the reactive layer(s) 3, which extends the active life of the reactive layer(s) 3. In some embodiments, the prefilter layer 2 may be a HEPA filter layer, which is known to create a measurable pressure drop, or any other filtration layer.

At least one reactive layer 3 may attach to the outer members 5′ and possibly the inner supports 5, and/or may be otherwise restrained in the frame 1. In some embodiments, there is one reactive layer 3. In other embodiments there are two or more reactive layers 3. The reactive layers 3 may be “netted,” which a person of ordinary skill will understand as meaning that the reactive layers 3 may be made of reactive particulate, such as activated carbon particles, adhered to a net. The net is typically made of strands that intersect at a variety of possible angles, and adhere or are integral at the intersection to form an array of openings between the strands. In some embodiments, the net is adhered, welded or otherwise attached to the outer members 5′ around the entire periphery of the frame 1.

If a net layer has large enough openings, the net alone may not appreciably increase pressure drop. When a sufficient quantity of reactive particulate is adhered to the net and air is directed therethrough, substantial air contact with the reactive particulate occurs, permitting the air to react with, or otherwise be chemically affected by, the reactive particulate. The reactive particulate may be carbon, activated carbon, activated carbon with nanoparticles in the pores of the carbon particles, or any other reactive solid, including fibers and pellets.

When multiple netted layers are stacked in a parallel fashion to form one or more reactive layers 3, tortuous paths are formed between the adjacent net strands and particulate that guide air passing through the stack to make contact with much of the reactive particulate on the nets. This configuration causes the substances in the air that are capable of reacting with the particulate to react with the particulate, thereby removing some or all of the undesirable substances from the air.

Contemplated reactive layers 3 may be incapable of standing upright (in a vertical orientation) without external support due to the inability of the structure to support its own weight under the force of gravity. The reactive layers 3 may be referred to as carbon layers because carbon is a common reactive material that may be the particulate used in the reactive layers 3. An example of such carbon layers includes those marketed under the brand name AO Smith.

The reactive layers 3 may have a planar shape when lying horizontally and resting on a planar surface, and are therefore referred to as “sheets” or “panels.” Furthermore, such sheets or stacks of such sheets may be deformed into cylinders or other contemplated shapes and maintained in that shape by supports of a similar shape or by attaching reinforcements. For example, the filter apparatus 10 may be bent into a cylindrical shape and retained in that shape by bending the frame 1 in a cylindrical shape.

The containment layer 4 is attached to the frame 1 around the periphery and is designed to contain the reactive layers 3 within the frame 1, and also possibly to cause substantial particulate filtration of the air passing through the filter apparatus 10. Thus, it is contemplated that no air or gas passes through the filter apparatus 10 without passing through the containment layer 4. The containment layer 4 may be any material that is suitable for assisting in holding the reactive layers 3 in the desired position, which may be an upright, vertical position as shown in FIG. 5. When the filter apparatus 10 is in the vertical position of FIG. 5, the containment layer 4 prevents substantial sagging of the reactive layers 3 under their own weight while also containing virtually all components of the reactive layers 3 within the frame 1. The containment layer 4 may be attached to the downstream surface of the frame 1 by adhesive, welding, fasteners or being integrally molded into the frame 1. The frame 1 may be molded from a liquid or any other non-solid to have edges and/or other components of the containment layer 4 integrated into the frame 1.

It is contemplated that extremely small particles of carbon may pass through the containment layer 4, but those particles are preferably no larger than 100 mesh (i.e. about 150 micron). Based on the relative size difference, it may be estimated that anything larger than about 150 micron will be retained by the containment layer 4. It is also contemplated that particles greater than 150 micron in size can be restricted from passing through the last netted layer of the reactive layers 3 by varying the dimensions of the immobilized particles/pellets on that netted layer. In this configuration, greater than approximately 325 mesh (45 micron) particles may be restricted from passing through the containment layer 4. However, the particle size that is able to pass through the final netted carbon layer will depend on many factors, including the mesh size of the Granular Activated Carbon (GAC) or the pellet size, the number of reactive layers 3, the extent of the carbon loading, and the porosity of the containment layer 4. With a finer containment layer, it may be possible to control the particles that pass through.

The containment layer 4 may be high flow filtration fabric or HEPA filtration media, among others, and may be heat sealed to the frame 1 around the entire periphery. The containment layer 4 may be designed to prevent unwanted particles of carbon from entering the airstream when the filter apparatus 10 is used downstream of another particulate filter. This is not illustrated, but any conventional particulate filter is contemplated by a person of ordinary skill for use upstream or downstream from the filter apparatus 10.

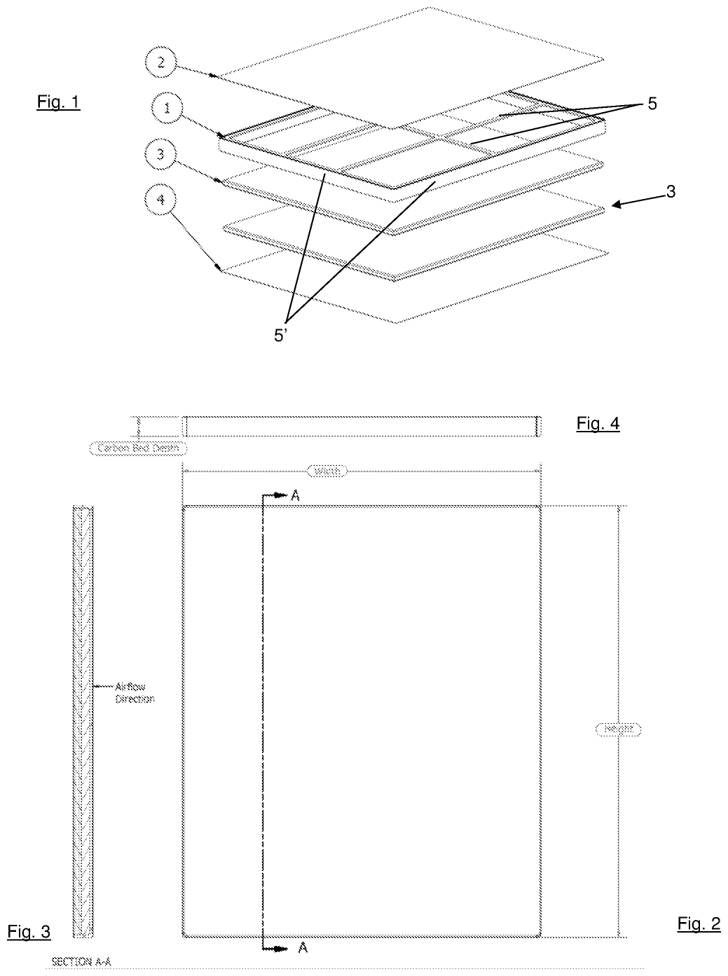

The frame 1 structure is sufficiently rigid to support the reactive layer(s) 3, as well as the prefilter layer 2 and the containment layer 4, when the layers 2, 3 and 4 are disposed in any orientation, in particular the vertical orientation shown in FIG. 3, and air or other gases are impelled as shown through the filter apparatus 10. The frame 1 may be made of plastic, a fiber-reinforced plastic composite, metal, paperboard or any suitable material that resists deformation during the use described herein. The frame 1 is preferably plastic, such as polyvinyl chloride (PVC) or any equivalent polymer, and may be injection molded, machined or formed to the desired shape in any other manner.

The frame 1 may be a single structure, or it may be two or more parts that are formed separately and then combined to constitute the frame 1 shown in FIG. 1. For example, the frame 1 may have an upstream part and a downstream part that are separated along a plane that is equidistant between the upstream-facing and downstream-facing sides of the frame 1 shown in FIG. 1. The separating plane may be parallel to the prefilter layer 2 shown in FIG. 1. The prefilter layer 2 may be molded into the upstream part of the frame 1, and the containment layer 4 may be molded into the downstream part of the frame 1. This design with the layers 2 and 4 integrated into the separate upstream and downstream parts of the frame 1 allows for the upstream and the downstream parts to be manufactured separately and simply attached together during assembly of the filter apparatus 10. Such a configuration may contain the reactive layer(s) 3 between the prefilter layer 2 and the upstream part of the frame and the containment layer 4 and the downstream part of the frame.

The inner supports 5 may be structural webs with one portion (e.g., about half) of each of the inner supports 5 formed on the upstream part and another portion formed on the downstream part. Such a configuration disposes the inner support portions in close proximity to one another when the frame parts are assembled. In an embodiment with such a configuration, the upstream part of the frame and the downstream part of the frame may be attached together, thereby trapping the reactive layers 3 between the upstream and downstream inner support portions, as well as within the outer members 5′ at the periphery of the reactive layers 3. The reactive layers 3 are thereby held from movement relative to the frame during use so that no gas or air may pass through the filter apparatus 10 without passing through the reactive layers 3. In an alternative embodiment, the inner supports 5 may be formed on only one part of the frame, and the reactive layers 3 may be supported by the inner supports 5 at only one side, such as the downstream side. In all contemplated embodiments, the inner supports 5 hold the reactive layers 3 in place in the frame 1 and prevent the reactive layers 3 from sagging or otherwise deforming under the force of their weight, or the force of airflow, or both, in any orientation, but particularly when the apparatus 10 is disposed in an upright, vertical orientation as shown in FIG. 5.

The carbon particles used in the reactive layers 3 may be various shapes, and include at least granular and pellet shapes. Pellet shapes are generally cylindrical with a circular cross-section, while granular shapes are randomly shaped and rough on their exterior but tend to have sides that are not substantially larger or smaller than other sides. The particles used in different reactive layers may vary from layer to layer. Thus, in a plurality of reactive layers 3 within a filter apparatus, a single netted carbon layer may have all granular particulate, a different netted carbon layer may have all pellet particulate and still another, different netted carbon layer may have a combination of pellet and granular particulate. Furthermore, one layer may remove one gaseous constituent of the air, and another layer may remove another gaseous constituent of the air. Each different layer may have different particulate for removing the gaseous constituent, or every layer may have the same particulate and have been chemically or otherwise treated to remove different gaseous constituents. For example, one layer may have activated carbon particles, and another layer may have activated carbon particles with MnOx nanoparticles within the pores of the activated carbon particles, wherein each layer removes a different gaseous component, or the layers remove the same gaseous component(s) in a different manner or with greater efficiency.

Variations in reactive particle size and density are also contemplated, both within a given netted carbon layer and from netted carbon layer to netted carbon layer within the same filter apparatus. Variation in carbon particle size and density may be accompanied by a corresponding variation in shape (e.g., circular, hexagonal or square) of the opening of the net and size (as low as 4 micron and as large as 20 mm) of the opening of the net. Further variations in thickness of the net are contemplated, and may range between 0.05 mm and 2.0 mm, in order to provide the best air flow or for any other purpose.

It is contemplated that any of the reactive layers 3 may be designed to remove specific, different gases, and each reactive layer 3 may be designed differently from one or more other reactive layers 3 in the same filter apparatus to enhance the designed layer's sorption and catalytic capacity for specific gases. For example, one reactive (netted carbon) layer can be designed to more efficiently remove VOCs (such as formaldehyde, BTX and toluene) and another reactive (netted carbon) layer in the same filter apparatus can be designed to more efficiently remove inorganic gases (such as Ozone (O₃) and SO₂) more efficiently. It is known that BTX is the designation used for mixtures of benzene, toluene, and the three xylene isomers.

It is further contemplated that the molecular efficiency can be improved by incorporating different carbon form factors in different layers of the same filter apparatus. For example, a filter apparatus may have a one layer with only pellets (e.g., 1.0 mm to 4.0 mm diameter) and one layer with only granules (e.g., 50 micron to 2000 micron). In an alternative example, one layer may have carbon pellets sandwiched between two other layers that have only granules (or vice versa) for a better air dynamics, lower pressure drop and subsequently lower noise, etc.

The carbon particle size may be varied widely. For example, for granular carbon the particles may be as large as 4×8 mesh (2.5-4.5 mm) and as small as top 325 mesh (44 micron). This includes 6×12, 8×16, and 20×50 mesh sizes. For pellet carbon, the particles may be as large as 4.0 mm and as small as 1.0 mm, with an average diameter size of 2.0 mm contemplated. The activity of the carbon in the netted layers can be varied from 50 to 100% CTC (carbon tetrachloride) from upstream to downstream layers so that the molecular filtration is more efficient for the equilibrium.

In general, the filter apparatus 10 retains and orients each of the prefilter layer 2, the reactive layer(s) 3 and the containment layer 4 to the air flow in such a way that substantial variability from one filter apparatus to another can be made with little impact of one layer on another. As an example, one reactive layer may be replaced by a different reactive layer, and this will have little to no impact on the other reactive layers. Such a variation may be desirable when a new gaseous constituent is encountered in the air stream, or when a new reactive layer is developed and proven effective. Such variations are possible because the frame and the prefilter and containment layers may not affect the reactive layers substantially. This enables one to vary the embodiments of the invention substantially. For example, the reactive layers 3 may be varied in any characteristic (e.g., thickness, pressure drop, reactivity, particle size, and/or particle density) without significantly affecting the prefilter layer 2 or the containment layer 4. Similarly, the prefilter layer 2 and the containment layer 4 may be varied substantially without significantly affecting the reactive layers 3.

The rigid feature of the frame 1 allows the reactive layers 3 to serve, in one sense, as a separate filter that can be used independently or in conjunction with other air filter layers, such as a particulate HEPA filter layer. This gives the filter designer freedom to modify one or more layers without substantially impacting the other layers, and therefore without concern of how the change in reactive layers may affect other layers. As a result, one reactive layer may be designed to react with one substance in the air, and another reactive layer may be designed to react with an entirely different substance in the air. In view of the configuration of the invention, the change to the reactive layers would not have a negative, or possibly any, effect on any other layers. Furthermore, because of the mechanical support of the frame 1 on the reactive layers 3, a reactive layer may be positioned therein with little to no concern for its need for mechanical support by other layers of the filter apparatus 10 or for self-support.

When the assembled filter apparatus 10 (FIG. 5) is placed in an air stream, it suspends the carbon or other reactive particles in the airstream in such a way that air that passes substantially perpendicularly through the substantially planar filter apparatus 10 is forced to come into contact with activated carbon, or whatever reactive particulate is in the reactive layer 3 or layers. When the apparatus 10 is used in an air moving device, such as an HVAC system, room air purifier, or any other air-moving device, the gaseous contaminants in the air can be removed more quickly and typically by using less carbon when the filter apparatus 10 is installed in the device, than the same device with a conventional filter. In one embodiment, large particles are removed by the upstream layer 2, gaseous substances are removed by the reactive layer 3 and smaller particles are removed by the downstream layer 4. Furthermore, by using separate and different reactive layers 3 of carbon-coated netting, it is possible to target the removal of specific gases and/or odors with one or more reactive layers. This may be accomplished by using two reactive layers 3, one of which contains a target-specific type of material that will treat the air to remove one target gas (or multiple target gases) and the second of which contains a second target-specific type of material that will treat the air to remove another, different target gas (or multiple target gases).

Furthermore, because the reactive particles in the reactive layers 3 are positioned across the path of the entire airstream without substantial room for air to bypass the reactive particles, less carbon or other reactive particles are required to perform the same level of cleaning when compared to conventional filters. For example, experimentation has shown that about one-half to one-quarter of the carbon is necessary to reduce the gaseous contents of the air using the filter apparatus 10 as compared to a conventional filter. With lower pressure drop across the filter apparatus 10 than conventional products, the filter apparatus 10 typically requires less force to move air through the reactive layer(s). As a result, when retrofitting the apparatus 10 in an existing air cleaning device, the air cleaning device will clean the air faster due to higher airflow. This results in more air turns in a given space over a given time period.

The orientation of reactive layers that have different particle size distribution can be arranged in either direction: either with the layer having larger particles positioned upstream of the layer having smaller particles, or with the layer having larger particles downstream of the layer having smaller particles. However, a netted reactive layer having larger carbon particles is preferably placed upstream of a netted reactive layer having smaller carbon particles in order for the finer carbon particle layer to perform a “polishing” filtration after the air has passed through the larger particles. To remove a wide variety of air pollutants, different chemical treatments can be carried out by different carbon particles. These different carbon particles can be immobilized on different reactive layers and/or in different orientations to clean the air more efficiently for the mixed gaseous stream (e.g. single and multiple VOCs and inorganic gases). As an example, one carbon layer may have pellet particles in one layer and much smaller carbon granules in a downstream layer.

FIG. 5 is a magnified view of FIG. 3. The apparatus 10 may be used in an airstream by itself or it may have other filtration elements integrated into it. For example, the downstream containment layer 4 may be a HEPA filter layer. The disclosed product may be used in a room air purifier, a residential or commercial HVAC system or any other product in which air is moved through a filter, and the apparatus 10 may be disposed just upstream of, or just downstream of, a conventional particle filtration device. Furthermore, although the apparatus 10 is shown as planar, it is contemplated that it could be modified to be cylindrical, pleated or any other shape.

Some of the contemplated reactive layers in the filter apparatus 10 are molecular filtration layers, which may be characterized as a VOC removal layer. Another contemplated layer includes inorganic gas removal layers, which can be further divided by gases that such layers selectively remove, including, without limitation, sulfur-containing gases and NOx emissions. These molecular filtration reactive layers may be constructed using different carbons with different activities, for example activities as high as 1,500-2,000 m²/g (Brunauer-Emmett-Teller (BET)) using different structures such as carbon granules, cylindrical pellets, spherical beads, different precursors like hard shells (coconut, walnut, etc.), bituminous coal and wood-based, and also treated or impregnated with selective chemical reagents for the removal of the corresponding gases. The number of reactive layers, the carbon treatment of the reactive layers, the shape and/or size of the particulate, the density, the shape and size of the net openings and other factors may all be modified from reactive layer to reactive layer, or within a given reactive layer.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A filter for removing gaseous components from a gas stream, the filter comprising
(a) a frame having at least one outer member and at least one support member mounted to the outer member;
(b) a prefilter layer disposed in the frame;
(c) at least one reactive layer disposed in the frame downstream from the prefilter layer, wherein the at least one reactive layer includes particulate that removes at least some of the gaseous components from the gas stream; and
(d) a containment layer disposed in the frame downstream from the at least one reactive layer.

2. The filter in accordance with claim 1, wherein the particulate in the at least one reactive layer is adhered to a net.

3. The filter in accordance with claim 2, wherein the particulate is activated carbon.

4. The filter in accordance with claim 2, wherein the at least one reactive layer further comprises:
(a) a first reactive layer with particulate adhered to a net, wherein the first reactive layer is configured to remove a first gaseous component from the gas stream; and
(b) a second reactive layer that includes particulate adhered to a net, wherein the second reactive layer is configured to remove a second gaseous component from the gas stream, wherein the first gaseous component varies in chemical composition from the second gaseous component.

5. The filter in accordance with claim 4, wherein the first gaseous component is a volatile organic compound and the second gaseous component is an inorganic compound.

6. The filter in accordance with claim 4, wherein the first reactive layer has different sorption and catalytic capacity than the second reactive layer.

7. The filter in accordance with claim 4, wherein the particulate in the first reactive layer is activated carbon granules and the particulate in the second reactive layer is activated carbon pellets.

8. A filter for removing gaseous components from a gas stream flowing along a path from upstream to downstream, the filter comprising:
(a) a rectangular frame defined by four outer members disposed around a frame periphery and at least one support member connected at opposite ends to at least two of the four outer members and spanning a gap between at least two of the four outer members;
(b) a prefilter layer disposed in the frame;
(c) at least one reactive layer disposed in the frame downstream from the prefilter layer, wherein the reactive layer includes particulate that removes at least some of the gaseous components from the gas stream; and
(d) a containment layer disposed in the frame downstream from the at least one reactive layer.

9. The filter in accordance with claim 8, wherein the frame has an upstream part with an upstream-facing surface and a downstream part with a downstream-facing surface, the upstream part and the downstream part are separated along a separating plane between the upstream-facing and downstream-facing surfaces, and the separating plane is substantially parallel to the at least one reactive layer.

10. The filter in accordance with claim 9, wherein the prefilter layer is molded into the upstream part and the containment layer is molded into the downstream part.

11. The filter in accordance with claim 8, wherein the particulate in the at least one reactive layer is adhered to a net.

12. The filter in accordance with claim 11, wherein the particulate is activated carbon.

13. The filter in accordance with claim 11, wherein the at least one reactive layer further comprises:
(a) a first reactive layer with particulate adhered to a net, wherein the first reactive layer is configured to remove a first gaseous component from the gas stream; and
(b) a second reactive layer that includes particulate adhered to a net, wherein the second reactive layer is configured to remove a second gaseous component from the gas stream, wherein the first gaseous component varies in chemical composition from the second gaseous component.

14. The filter in accordance with claim 13, wherein the first gaseous component is a volatile organic compound and the second gaseous component is an inorganic compound.

15. The filter in accordance with claim 13, wherein the first reactive layer has different sorption and catalytic capacity than the second reactive layer.

16. The filter in accordance with claim 13, wherein the particulate in the first reactive layer is activated carbon granules and the particulate in the second reactive layer is activated carbon pellets.
